(19) United States
(12) Patent Application Publication
(10) Pub. No.: US 2024/0103510 A1
(43) Pub. Date: Mar. 28, 2024

(54) ROOT CAUSE ANALYSIS TOOL FOR ALARMS

(71) Applicants: CALIFORNIA INSTITUTE OF TECHNOLOGY, Pasadena, CA (US); CHEVRON U.S.A. Inc., San Ramon, CA (US)

(72) Inventors: Virisha Timmaraju, Pasadena, CA (US); Eric Junkins, Westminster, CO (US); Valentinos Constantinou, Pasadena, CA (US); Asitang Mishra, Frisco, TX (US); Sakthivel Kandasamy, Houston, TX (US)

(21) Appl. No.: 18/271,986

(22) PCT Filed: Jan. 13, 2022
(86) PCT No.: PCT/US22/12364

§ 371 Date: Jul. 12, 2023

Related U.S. Application Data
(60) Provisional application No. 63/137,553, filed on Jan. 14, 2021.

(51) Int. Cl. G05B 23/02

(52) U.S. Cl. CPC G05B 23/027; G05B 23/0275

(57) ABSTRACT

Relationships between alarms are modeled using a graph to identify root cause of a sequence of alarms (an alarm flood). The nodes of the graph represent different alarms, and the edges between the nodes are scored using pairwise analysis of when the alarms occurred. The graph is divided into multiple subgraphs representing alarm clusters. Root cause analysis of the sequence of alarms is performed by generating and simplifying directed graphs for events within the alarm clusters.

### CROSS-REFERENCE TO RELATED APPLICATION

The present application claims the benefit of U.S. Provisional Application No. 63/137,553, entitled “RAD: Rapid Alarm Diagnostics,” which was filed on Jan. 14, 2021, the entirety of which is hereby incorporated herein by reference.

### STATEMENT REGARDING FEDERALLY SPONSORED RESEARCH OR DEVELOPMENT

This invention was made with government support under Grant No. 80NMO0018D0004 awarded by NASA (JPL). The government has certain rights in the invention.

### FIELD

The present disclosure relates generally to the field of performing root cause analysis for alarms using a graph that models relationships between the alarms.

### BACKGROUND

Alarms for a facility may alert operators about deviations in operations and allow operators to return the facility to normal operations. Alarm floods, however, may overwhelm the operators and make it difficult for the operators to return the facility to normal operations. For example, diagnostic information provided by the alarms may be lost in the presence of alarms that occur simultaneously/in sequence.

### SUMMARY

This disclosure relates to performing alarm root cause analysis. Alarm information and/or other information may be obtained. The alarm information may define occurrences of alarms within a time period. Pairs of alarms may be identified based on the occurrences of the alarms and/or other information. Correlation scores for the pairs of alarms may be determined based on the occurrences of individual alarms within individual pairs of alarms and/or other information. A correlation alarm graph for the alarms may be generated. The correlation alarm graph may include nodes representing the alarms and edges representing the correlation scores. Alarm clusters may be identified based on filtering of the correlation alarm graph and/or other information. Root cause analysis of a sequence of alarms may be facilitated based on the alarm clusters and/or other information.

A system for performing alarm root cause analysis may include one or more electronic storage, one or more processors and/or other components. The electronic storage may store alarm information, information relating to alarms, information relating to occurrences of alarms, information relating to alarm pairs, information relating to correlation scores, information relating to correlation alarm graphs, information relating to alarm clusters, information relating to root cause analysis, and/or other information.

The processor(s) may be configured by machine-readable instructions. Executing the machine-readable instructions may cause the processor(s) to facilitate performing alarm root cause analysis. The machine-readable instructions may include one or more computer program components. The computer program components may include one or more of an alarm component, an alarm pair component, a correlation score component, a correlation alarm graph component, an alarm cluster component, a root cause analysis component, and/or other computer program components.

The alarm component may be configured to obtain alarm information and/or other information. The alarm information may define occurrences of alarms within a time period.

The alarm pair component may be configured to identify pairs of alarms. The pairs of alarms may be identified based on the occurrences of the alarms and/or other information. In some implementations, identification of the pairs of alarms based on the occurrences of the alarms may include identification of alarm pairs with trigger times within a threshold duration of time.

The correlation score component may be configured to determine correlation scores for the pairs of alarms. The correlation scores for the pairs of alarms may be determined based on the occurrences of individual alarms within individual pairs of alarms and/or other information.

In some implementations, determination of the correlation scores for the pairs of alarms based on the occurrences of individual alarms within individual pairs of alarms includes, for a given pair of alarms including a first alarm and a second alarm: generation of equal-length lists for the given pair of alarms, with the equal-length lists including a first list for the first alarm and a second list for the second alarm; population of values of the equal-length lists for the given pair of alarms based on the occurrences of the individual alarms and/or other information; and determination of a given correlation score for the given pair of alarms based on the values of the equal-length lists for the given pair of alarms and/or other information. In some implementations, at least one value of the first list may be determined based on decay of another value of the first list.

The correlation alarm graph component may be configured to generate a correlation alarm graph for the alarms. The correlation alarm graph may include nodes representing the alarms and edges representing the correlation scores.

The alarm cluster component may be configured to identify alarm clusters. The alarm clusters may be identified based on filtering of the correlation alarm graph and/or other information. In some implementations, identification of the alarm clusters based on filtering of the correlation alarm graph may include removal of the edges of the correlation alarm graph representing the correlation scores below a threshold correlation score. The removal of the edges of the correlation alarm graph may result in subgraphs representing the alarm clusters.

The root cause analysis component may be configured to facilitate root cause analysis of a sequence of alarms. The root cause analysis of the sequence of alarms may be facilitated based on the alarm clusters and/or other information.

In some implementations, facilitation of the root cause analysis of the sequence of alarms based on the alarm clusters may include: reception of an alarm event stream; separation of the alarm event stream into one or more of the alarm clusters; and generation of one or more directed alarm graphs from the alarm event stream separated into the one or more of the alarm clusters. In some implementations, the generation of the directed alarm graph(s) may include, for a given directed alarm graph generated from an alarm event stream portion separated into a given alarm cluster: generation of alarm sortings based on removal of duplicative alarms in the given alarm cluster; and determination of directions in the given directed alarm graph based on alarm directions in the alarm sortings and/or other information. In some implementations, the given directed alarm graph may be reduced to preserve a longest path between two nodes representing two alarms.

In some implementations, facilitation of the root cause analysis of the sequence of alarms based on the alarm clusters may include determination of a root-causeness score for a given alarm. The root-causeness score may indicate an extent to which the given alarm occurs at a beginning of an alarm flood. In some implementations, facilitation of the root cause analysis of the sequence of alarms based on the alarm clusters may include determination of a root cause of an alarm flood.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for performing alarm root cause analysis.

FIG. 2 illustrates an example method for performing alarm root cause analysis.

FIG. 3 illustrates an example process for performing alarm root cause analysis.

FIG. 4 illustrates an example sequence of alarms.

FIG. 5 illustrates an example use of decayed values for correlation score determination.

FIG. 6A illustrates an example correlation alarm graph.

FIG. 6B illustrates example alarm clusters.

FIG. 7 illustrates example sortings of alarms.

FIG. 8 illustrates example generation of a directed alarm graph.

### DETAILED DESCRIPTION

The present disclosure relates to alarm root cause analysis. Relationships between alarms are modeled using a graph to identify root cause of a sequence of alarms (an alarm flood). The nodes of the graph represent different alarms, and the edges between the nodes are scored using pairwise analysis of when the alarms occurred. The graph is divided into multiple subgraphs representing alarm clusters. Root cause analysis of the sequence of alarms is performed by generating and simplifying directed graphs for events within the alarm clusters

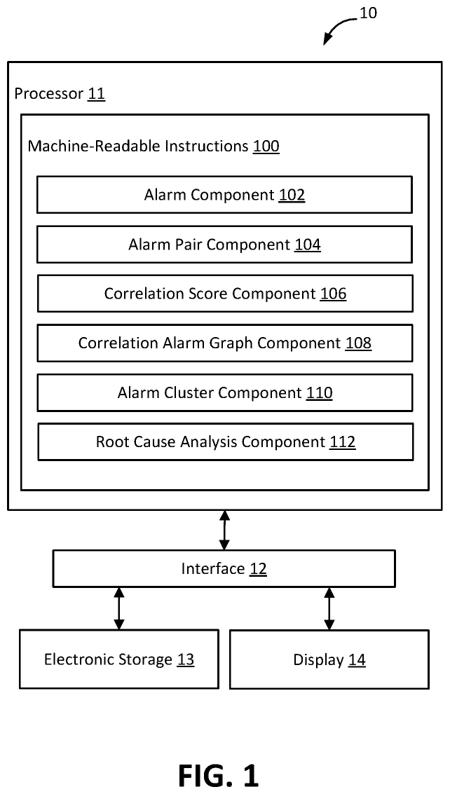

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Alarm information and/or other information may be obtained by the processor 11. The alarm information may define occurrences of alarms within a time period. Pairs of alarms may be identified by the processor 11 based on the occurrences of the alarms and/or other information. Correlation scores for the pairs of alarms may be determined by the processor 11 based on the occurrences of individual alarms within the individual pairs of alarms and/or other information. A correlation alarm graph for the alarms may be generated by the processor 11. The correlation alarm graph may include nodes representing the alarms and edges representing the correlation scores. Alarm clusters may be identified by the processor 11 based on filtering of the correlation alarm graph and/or other information. Root cause analysis of a sequence of alarms may be facilitated by the processor 11 based on the alarm clusters and/or other information.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store alarm information, information relating to alarms, information relating to occurrences of alarms, information relating to alarm pairs, information relating to correlation scores, information relating to correlation alarm graphs, information relating to alarm clusters, information relating to root cause analysis, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present alarm information, information relating to alarms, information relating to occurrences of alarms, information relating to alarm pairs, information relating to correlation scores, information relating to correlation alarm graphs, information relating to alarm clusters, information relating to root cause analysis, and/or other information.

An alarm may refer to a signal that provides a warning or an alert. An alarm may be generated based on occurrence of one or more conditions, such as a set of environmental conditions and/or systematic conditions. An alarm may provide contextual and/or diagnostic information about the state of a system. For example, alarms may be used to monitor operations at a well (e.g., drilling a well, extracting resources from a well). Alarms may be set up to detect deviations in operation of the well and to alert the operators of the well to different situations before those situations become escalated. Alarms for a facility may empower the operators to return the facility to normal operations. Alarms may be designed to alert the operators to changes in the facility's operational conditions and/or environment, which may be helpful in returning the facility to a normal state. Other types of alarms and alarms for other types of scenarios/facilities are contemplated.

Information provided by alarms may be lost during alarm floods. An alarm flood may refer to multiple alarms occurring in a sequence. An alarm flood may include more than a threshold number of alarms occurring within a set duration of time. An alarm flood may include multiple alarms occurring at the same time. The number of alarms in an alarm flood may overwhelm the operators, who may not be able to effectively respond to the large number of alarms occurring in the short duration of time. For example, information provided by the initial alarm may be lost in the presence of subsequent alarms. Information provided by individual alarms may be lost when many alarms are simultaneously activated.

The present disclosure provides a tool to enable root causes analysis for alarm floods. The tool effectively models functional relationships between alarms and enables prioritization of alarms based on their likelihood to be related to the root cause of a sequence of alarms. The tool provides fast, efficient, and safe analysis of alarms as they occur to provide feedback to the operators and enable the operators to return the facility to normal operating conditions. The tool utilizes historical information on alarms to understand relationships between the alarms. Global and local patterns of alarms are analyzed using graph analysis to determine directional relationships between alarms, as well as the likelihood of alarms as being the root cause of a sequence of alarms. The tool may enable real-time identification of root cause alarms. The learning obtained from historical information may be updated with information from new alarms.

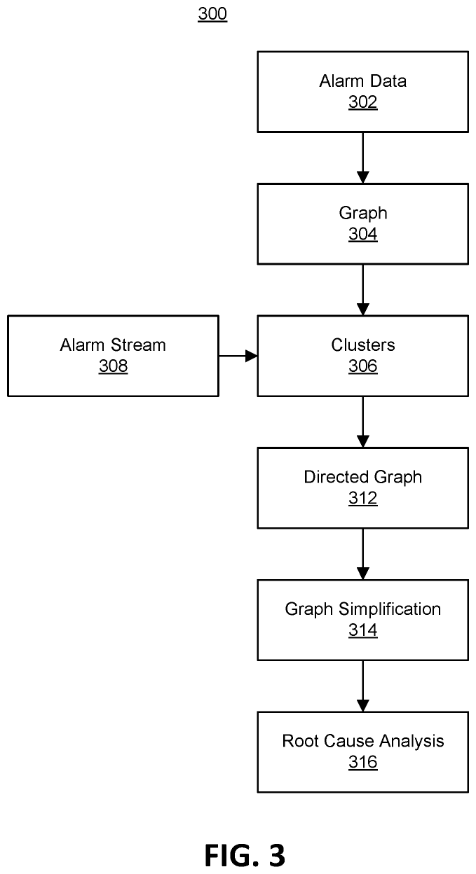

FIG. 3 illustrates an example process 300 for performing alarm root cause analysis. In the process 300, alarm data 302 may be obtained. The alarm data 302 may include historical data about timing of occurrences of alarms (e.g., timestamps of alarm events and types of alarms corresponding to the alarm events) over a period of time. The alarm data 302 may be analyzed to generate a graph 304 that represents relationships between the alarms. The graph 304 may include nodes that represent the alarms and edges that represent correlation between the alarms. Correlation analysis for pairs of alarms may be performed to determine correlation scores for the pairs of alarms. Two alarms may be paired up for correlation analysis based on the two alarms occurring within a threshold duration of time.

The graph 304 may be divided into clusters 306 using the correlation scores for the pairs of alarms. Edges corresponding to pairs of alarms that have correlation scores that satisfy a correlation criterion (e.g., correlation scores above a correlation threshold value) may be retained within the graph 304 while edges corresponding to pairs of alarms that have correlation scores that do not satisfy the correlation criterion (e.g., correlation scores below a correlation threshold value) may be removed from the graph 304. Removal of such edges may result in division of the graph 304 into subgraphs, with individual subgraphs representing individual ones of the clusters 306.

An alarm stream 306 may be received and separated into different ones of the clusters 306. The alarm stream 306 may include alarm data for alarms to be analyzed. The alarms separated into the clusters 306 may be analyzed to form a directed graph 312 for individual ones of the clusters 306. The direction of paths within the directed graph 312 may correspond to the time sequence in which the alarms occurred, such that the directed graph 312 includes a path from a first node to a second node based on the alarm represented by the first node occurring before the alarm represented by the second node in the alarm stream 308. Graph simplification 314 may be performed on the directed graph 312 to preserve the longest paths within the directed graph 312. The simplified, directed graph may be used to perform root cause analysis 316 (e.g., determine a score for an alarm to indicate the extent to which the alarm occurs at the beginning of an alarm flood; determine which of the alarms was a root cause of an alarm flood).

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate performing alarm root cause analysis. The machine-readable instructions 100 may include one or more computer program components. The machine-readable instructions 100 may include an alarm component 102, an alarm pair component 104, a correlation score component 106, a correlation alarm graph component 108, an alarm cluster component 110, a root cause analysis component 112, and/or other computer program components.

The alarm component 102 may be configured to obtain alarm information and/or other information. Obtaining alarm information may include one or more of accessing, acquiring, analyzing, determining, examining, identifying, loading, locating, opening, receiving, retrieving, reviewing, selecting, storing, and/or otherwise obtaining the alarm information. The alarm component 102 may obtain alarm information from one or more locations. For example, the alarm component 102 may obtain alarm information from a storage location, such as the electronic storage 13, electronic storage of a device accessible via a network, and/or other locations. The alarm component 102 may obtain alarm information from one or more hardware components (e.g., a computing device) and/or one or more software components (e.g., software running on a computing device). In some implementations, the alarm information may be obtained from one or more users (e.g., operators). For example, a user may interact with a computing device to input the alarm information (e.g., upload the alarm information, identify which alarm information will be used).

The alarm information may define occurrences of alarms within a time period. Occurrences of alarms within a time period may refer to when the alarms occurred (e.g., activated, triggered, observed) within a period of time. Occurrences of alarms within a time period may include individual occurrences of alarms within the time period, along with the identity of the alarms that occurred. For example, the alarm information may include a list of alarm identifiers, along with timestamps of when different alarms were triggered. As another example, the alarm information may include a list of timestamps of when alarms were triggered, along with alarm identifiers corresponding to individual timestamps. The alarm information may include historical alarm data from which the graph of alarm relationships is to be constructed. Other information may be included within the alarm information.

The alarm information may occurrences of alarms within a time period by including information that defines one or more qualities, attributes, features, and/or other aspects of the occurrences of alarms within a time period. For example, the alarm information may define an occurrence of an alarm within a time period by including information that sets forth the timing of when the alarm occurred and the identity of the alarm, and/or information that is used to determine the timing of when the alarm occurred and the identity of the alarm. Other types of alarm information are contemplated.

The alarm pair component 104 may be configured to identify pairs of alarms. Different pairs of alarms may be identified from the occurrences of alarms within the time period. The pairs of alarms may be identified from the occurrences of alarms within the time period (e.g., historical alarm data) for determination of correlation scores between the pairs of alarms. The pairs of alarms may be identified based on the occurrences of the alarms and/or other information. That is, the pairs of alarms for which correlation scores are to be determined may be identified based on when the alarms occurred within the time period.

In some implementations, identification of the pairs of alarms based on the occurrences of the alarms may include identification of alarm pairs with trigger times within a threshold duration of time. A trigger time of an alarm may refer to when the alarm was triggered, activated, and/or observed. Thus, the pairs of alarms may be identified based on individual alarms within the pairing having been triggered, activated, and/or observed within a threshold duration of time. Use of the threshold duration of time to identify pairings of alarms may effectuate filtering of alarms for correlation score determination. That is, rather than analyzing every pairs of alarms that occurred within the time period to determine the correlation scores, only those pairs of alarms where the alarms occurred within the threshold duration of time may be analyzed to determine correlation scores. Other factors may be considered to identify the pairs of alarms.

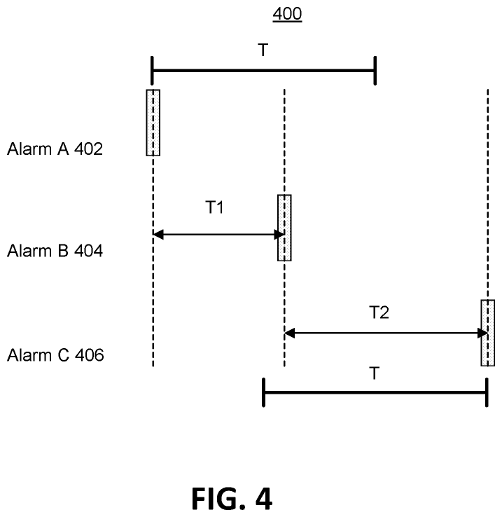

FIG. 4 illustrates an example sequence 400 of alarms. The sequence 400 may include occurrences of an alarm A 402, an alarm B 404, and an alarm C 406, in that order. The alarm B 404 may occur a time duration T1 after the alarm A 402. The alarm C 306 may occur a time duration T2 after the alarm B 404. A threshold duration of time T may be used to identify pairs of alarms. An alarm pair including the alarm A 402 and the alarm B 404 may be identified based on the time duration T1 between those alarms being shorter than the threshold duration of time T. An alarm pair including the alarm B 404 and the alarm C 406 may be identified based on the time duration T2 between those alarms being shorter than the threshold duration of time T. An alarm pair including the alarm A 402 and the alarm C 306 may not be identified based on the time duration (T1+T2) between those alarms being longer than the threshold duration of time T.

The correlation score component 106 may be configured to determine correlation scores for the pairs of alarms. Determining a correlation score for a pair of alarms may include ascertaining, approximating, calculating, establishing, estimating, finding, identifying, obtaining, quantifying, selecting, setting, and/or otherwise determining the correlation score for a pair of alarms. The correlation scores may be determined for the pairs of alarms identified by the alarm pair component 104. The correlation scores may be determined to be used for/associated with edges within a correlation alarm graph for the alarms. A correlation score for a pair of alarms may indicate an extent to which the alarms within the pair are correlated. Correlation between alarms may refer to a mutual relationship and/or connection between the alarms. Correlation between alarms may refer to one alarm affecting another alarm or one alarm depending on another alarm. A high correlation between two alarms may indicate that two alarms are likely to occur together or that an occurrence of one alarm is likely to result in an occurrence of the other alarm. A low correlation between two alarms may indicate that that two alarms are not likely to occur together or that an occurrence of one alarm is likely to not have an impact on the occurrence of the other alarm.

The correlation scores for the pairs of alarms may be determined based on the occurrences of individual alarms within individual pairs of alarms and/or other information. A correlation scores for a pair of alarms may be determined based when the alarms within the pair occurred. That is, the correlation score for a specific pair of alarms may be determined based on when the alarms within the pair occurred within the time period. One or more correlation functions may be used to perform a pairwise comparison when the alarms in the pair occurred to determine the correlation score for the pair.

In some implementations, determination of the correlation scores for the pairs of alarms based on the occurrences of individual alarms within individual pairs of alarms may include (1) generation of equal-length lists, (2) population of values of the equal-length lists based on the occurrences of the individual alarms, and (3) determination of the correlation scores based on the values of the equal-length lists and/or other information. The equal-length lists may be generated and populated to perform pairwise correlation analysis.

For example, for a pair of alarms including a first alarm and a second alarm, the equal-length lists may be generated to include a first list for the first alarm and a second list for the second alarm. The equal-length lists may have space for values for different moments in time at which alarms have occurred. The values of the first list may be populated based on when the first alarm occurred and the values of the second list may be populated based on when the second alarm occurred. One or more of the values of an equal-length list may be determined based on decay of another value of the equal-length list. The decayed value may be used in place of a non-occurrence value (e.g., 0) when the alarm has not occurred for a particular moment in time. The correlation score for the pair of alarms may be determined based on the values of the first list, the values of the second list, and/or other information.

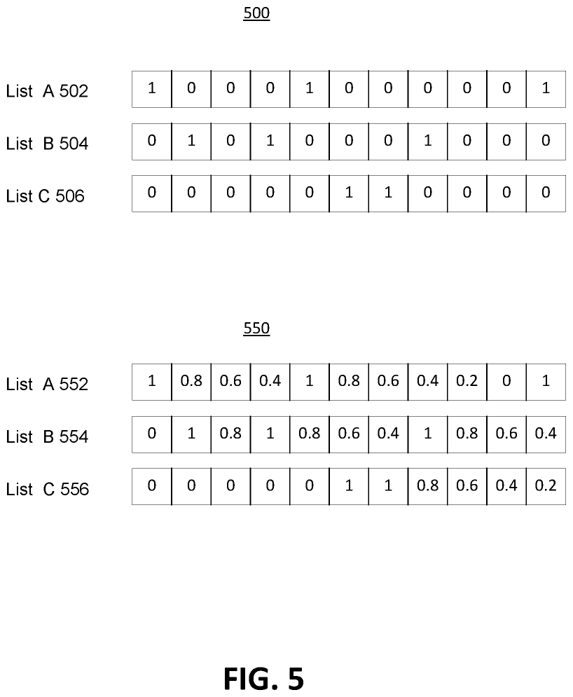

FIG. 5 illustrates an example use of decayed values for correlation score determination. In FIG. 5, equal-length lists 500 may be generated for alarms A, B, and C. The equal-length lists 500 may include a list A 502 for the alarm A, a list B 504 for the alarm B, and a list C 506 for the alarm C. The equal-length lists 502, 504, 506 may be made equal by inserting a space for value for every time moment at which any of the alarms A, B, or C occurred. The list A 502 may have originally included three values based on the alarm A having occurred three times within the time period, the list B 504 may have originally included three values based on the alarm B having occurred three times within the time period, and the list C 506 may have originally included two values based on the alarm C having occurred two times within the time period. To perform correlation analysis, the lists 502, 504, 506 may be made equal by expanding the list to include a space for every time moment at which any of the alarms A, B, C occurred.

The equal-length lists 502, 505, 506 may be populated with an occurrence value (e.g., 1) for every moment at which the corresponding alarm occurred and with a non-occurrence value (e.g., 0) for every moment at which the corresponding alarm did not occur. For example, referring to the list A 502, the first, fifth, and eleventh blocks may be populated with the value “1” based on the alarm A having occurred at those times, while other block may be populated with the value “0” based on the alarm A not having occurred at those times.

In FIG. 5, the lists 502, 504, 506 show that none of the alarms A, B, and C occurred at the same time. Performing correlation analysis using the values in the lists 502, 504, 506 will result in no correlation being found between pairs of alarms A and B, B and C, and A and C. To enable smart correlation analysis between alarms, decayed values are used to populate the list in place of non-occurrence values. A decayed value may refer to a value that has been changed from another value. For example, a decayed value may refer to a value that has been reduced from an occurrence value. The value may be decayed linearly or non-linearly over a duration of time. Once a list is populated with occurrence values, then those values may be decayed to fill in the empty spaces (that were previously filled with non-occurrence values).

For example, referring to FIG. 5, the equal-length lists 550 may be generated for alarms A, B, and C. The equal-length lists 550 may include a list A 552 for the alarm A, a list B 554 for the alarm B, and a list C 556 for the alarm C. The equal-length lists 552, 554, 556 may be made equal by inserting a space for value for every time moment at which any of the alarms A, B, or C occurred. The equal-length lists 552, 554, 556 may be populated with an occurrence value for every moment at which the alarm A, B, or C occurred, respectively. The equal-length lists 552, 554, 556 may be populated with a decayed value for every moment at which the corresponding alarm did not occur.

For example, referring to the list A 552, the first, fifth, and eleventh blocks may be populated with the value “1” based on the alarm A having occurred at those times. The second, third, and fourth box may be filled with decayed value based on the alarm A not having occurred at those time. The decayed value for the second block may include a value of 0.8, the decayed value for the third block may include a value of 0.6, and the decayed value for the fourth block may include a value of 0.4 based on linear decay of 0.2 per time block. For the sixth block, the decayed value may be 0.8 since the list A 552 was populated with the occurrence value of 1 in the fifth block. Use of other occurrence values, non-occurrence values, and decays are contemplated.

Performing correlation analysis using the values in the lists 552, 554, 556 will result in some correlation being found between pairs of alarms A and B, B and C, and A and C. One or more correlation functions may be used to determine the correlation score between different pairs of alarms. For example, Pearson Correlation Measure may be used to calculate correlation scores between different pairs of alarms/pairs of equal-length lists. Use of other correlation functions is contemplated.

In some implementations, the correlation scores may be determined as values within a range of values. For example, the correlation scores may be determined as values between minus one and one. Use of other range of values is contemplated. In some implementations, the correlation scores may be normalized. For example, the correlation scores may be normalized to values between zero and one. Other normalization of the correlation scores is contemplated.

The correlation alarm graph component 108 may be configured to generate a correlation alarm graph for the alarms. A correlation alarm graph may refer to a graph that represents relationships between the alarms. The correlation alarm graph may provide a knowledge representation of the alarms from which pairs have been identified and correlation scores have been determined. The correlation alarm graph may provide information on how the alarms relate to one another based on how they occurred in time.

The correlation alarm graph may represent alarms and relationships between alarms using nodes and edges. The correlation alarm graph may include nodes representing the alarms and edges representing the correlation scores between the respective alarms. A pair of nodes within the correlation alarm graph may represent a pair of alarms. An edge between the pair of nodes within the correlation alarm graph may represent the correlation score between the pair of alarms. An edge may represent a correlation score between a pair of alarms by including, having, being associated with, being related to, by defining, and/or otherwise representing the correlation score between the pair of alarms. In some implementations, a correlation score for an edge may represent the strength of the edge.

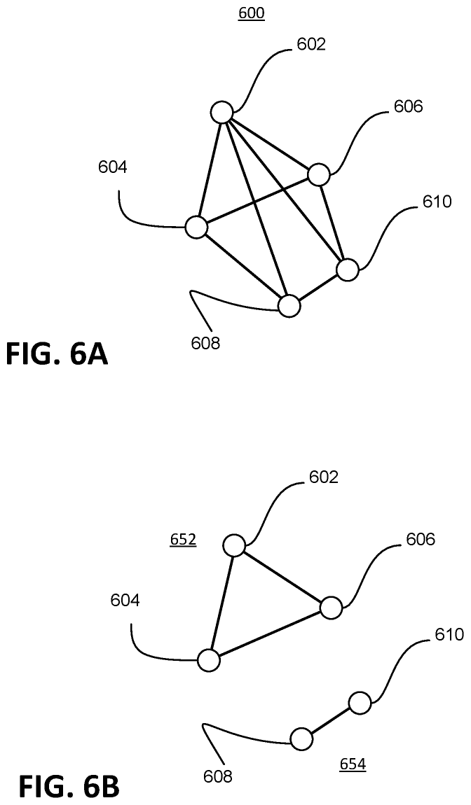

FIG. 6A illustrates an example correlation alarm graph 600. The correlation alarm graph 600 may include nodes 602, 604, 606, 608, 610. Individual nodes 602, 604, 606, 608, 610 may represent individual alarms. The correlation alarm graph 600 may include edges between the nodes 602, 604, 606, 608, 610. An edge may exist between two of the nodes within the correlation alarm graph 600 based on the two corresponding alarms being identified as a pair by the alarm pair component 104. For example, an edge may exist between the node 602 and the node 604 based on the alarms represented by the node 602 and the node 604 being identified as a pair by the alarm pair component 104. An edge may not exist between two of the nodes within the correlation alarm graph 600 based on the two corresponding alarms not being identified as a pair by the alarm pair component 104. For example, an edge may not exist between the node 604 and the node 610 based on the corresponding alarms not being identified as a pair by the alarm pair component 104.

The edges of the correlation alarm graph 600 may represent the correlation scores between individual pairs of alarms. For example, the edge between the node 602 and the node 604 may represent the correlation score for the pair of alarms represented by the node 602 and the node 604.

The alarm cluster component 110 may be configured to identify alarm clusters. An alarm cluster may refer to a group of alarms. An alarm cluster may refer to a group of related alarms. An alarm cluster may include two or more alarms. The alarm clusters may be identified based on filtering of the correlation alarm graph and/or other information. Filtering of the correlation alarm graph may include removal of one or more edges of the correlation alarm graph. Filtering o the correlation alarm graph may include division of the correlation alarm graph into multiple subgraphs, with individual subgraphs representing different alarm clusters.

In some implementations, identification of the alarm clusters based on filtering of the correlation alarm graph may include removal of edges of the correlation alarm graph representing correlation scores below a threshold correlation score. The correlation alarm graph may be filtered by removing edges that have correlation score below the threshold correlation score. For example, the threshold correlation score may separate strong edges (representing correlation scores higher than the threshold correlation score) from weak edges (representing correlation scores lower than the threshold correlation score), and the threshold correlation score may be used to remove the weak edges from the correlation alarm graph. Use of other criteria to remove the edges is contemplated.

The removal of the edges of the correlation alarm graph may result in subgraphs representing the alarm clusters. Removing the edges of the correlation alarm graph may divide the correlation alarm graph into multiple subgraphs. For example, removing the weak edges of the correlation alarm graph may divide the correlation alarm graph into multiple subgraphs that internally have strong edges. Individual subgraphs may represent an alarm cluster.

FIG. 6B illustrates example alarm clusters 652, 654. The alarm cluster 652 may include three alarms represented by the nodes 602, 604, 606. The alarm cluster 654 may include two alarms represented by the nodes 608, 610. The alarm clusters 652, 654 may be identified by removing edges from the correlation alarm graph 600. For example, edges between (1) nodes 602, 608, (2) nodes 602, 610, (3) nodes 604, 608, and (4) nodes 606, 610 may be removed based on the correlation scores for these edges being less than a threshold correlation score. Removal of these edges may result in division of the correlation alarm graph 600 into two subgraphs representing the alarm clusters 652, 654.

The root cause analysis component 112 may be configured to facilitate root cause analysis of a sequence of alarms. A sequence of alarms may refer to alarms that occur in a sequence. A sequence of alarms may refer to a grouping or a collection of alarms that occur over a duration of time. A sequence of alarms may refer to an order in which alarms occur over a duration of time. A sequence of alarms may refer to an arrangement of alarms in an order in which they occurred over a duration of time. A sequence of alarms may include alarms that occur in one or more alarm floods.

A root cause analysis of a sequence of alarms may refer to analysis of a root cause of the sequence of alarms. A root cause of a sequence of alarms may refer to an initiating cause of the sequence of alarms. A root cause of a sequence of alarms may refer to a factor that cause deviations in operations. A root cause of a sequence of alarms may refer to the core issue that caused the sequence of alarms. A root cause of a sequence of alarms may include one or more alarms in the sequence of alarms. A root cause of a sequence of alarms may have started the sequence of alarms. An alarm that identifies and/or arises from a root cause may be referred to as a root cause alarm. A root cause alarm may refer to an alarm that likely starts a sequence of alarms.

Analysis of the root cause of the sequence of alarms may include examination, evaluation, processing, studying, and/or other analysis of the root cause of the sequence of alarms. For example, analysis of the root cause of the sequence of alarms may include examination, evaluation, processing, studying, and/or other analysis of the relationships between the alarms to determine the dependencies between the alarms and to distinguish between the alarm(s) for the root cause of the alarms versus the alarms for subsequent deviations that happened as a result of the root cause of the alarms. Other types of root cause analysis of a sequence of alarms are contemplated.

The root cause analysis of the sequence of alarms may be facilitated based on the alarm clusters and/or other information. The root cause analysis component 112 may facilitate the use of the alarm cluster to perform root cause analysis of the sequence of alarms. The root cause analysis component 112 may facilitate use of information relating to and/or determined from the alarm clusters to perform root cause analysis of the sequence of alarms. For example, facilitating the root cause analysis of the sequence of alarms may include (1) presenting the alarm clusters on the display 14, (2) presenting information relating to and/or determined from the alarm clusters on the display 14, (3) presenting results of the root cause analysis on the display 14, (4) providing information relating to and/or determined from the alarm clusters to one or more root cause analysis processes, (5) performing the root cause analysis of the sequence of alarms using information relating to and/or determined from the alarm clusters, and/or (6) improving the root cause analysis of the sequence of alarms using information relating to and/or determined from the alarm clusters.

In some implementations, the results of the root cause analysis may be used to modify the information presented to the users. For example, the results of the root cause analysis may be used to provide real-time identification of the root cause/root cause alarms. The results of the root cause analysis may be used to provide a list of alarms along with ranking/probability on which alarms are the root cause and/or information on relationship/dependencies between the alarms (e.g., identification of which alarm caused which alarms).

Identification of the root cause/root cause alarms may be used to suppress consequential alarms dynamically. Consequential alarms may refer to alarms that follow other alarms (e.g., follow root cause alarms, follow other alarms). Consequential alarms may refer to alarms that likely to occur as part of a sequence of alarms pertaining to a particular root cause alarm. Suppressing consequential alarms may include hiding the consequential alarms from view/being report to the user. Suppressing consequential alarms may enable the user to focus on the diagnostic information provided by the root cause alarms. Suppressing consequential alarms may reduce the level of “noisy” information provided to the users. Suppressing consequential alarms may reduce the likelihood that the users will be overwhelmed by number and/or frequency of alarms.

In some implementations, facilitation of the root cause analysis of the sequence of alarms based on the alarm clusters may include reception of an alarm event stream and/or other information. Reception of an alarm event stream may include action of obtaining the alarm event stream. An alarm event stream may refer to a data stream of alarms occurrences. An alarm event stream may include information on occurrences of alarms within a time period. An alarm event stream may include information on occurrences of alarms as they occur or information on occurrences of alarms collected over a period of time. An alarm event stream may include real-time information on alarms or historical information on alarms.

The alarm event stream may be separated into one or more of the alarm clusters. A portion of the alarm event stream including occurrences of one or more alarms may be separated into an alarm cluster based on the type of the alarms that have occurred and the types of the alarms inside the alarm cluster. A portion of the alarm event stream may be separated into an alarm cluster based on the types of alarms in the portion matching the types of alarms inside the alarm cluster. Such separation of alarms into alarm clusters enable analysis based on relationship (not direction) between the alarms.

Alarms that are separated by more than a quiet threshold duration of time may be split into separate groups for separation in the alarm clusters. For example, the alarm event stream may be analyzed to detect quiet times in the alarm event stream. A quiet time may refer to a time in the alarm event stream when no alarms are being triggered. Alarms separated by quiet times of at least the quiet threshold duration may be split into separate groups for separation in the alarm clusters. For example, the alarm event stream may include two sub-sequences of alarms, with the sub-sequences being separated by a quiet time that is longer than the quiet threshold duration. Rather than separating the entire sequence of alarm into the alarm clusters, the sequence may be separated into two sub-sequences, and the two-subsequences may be individually separated into the alarm clusters. Such separation of alarms using the quiet threshold duration results in individual analysis of separate alarm floods.

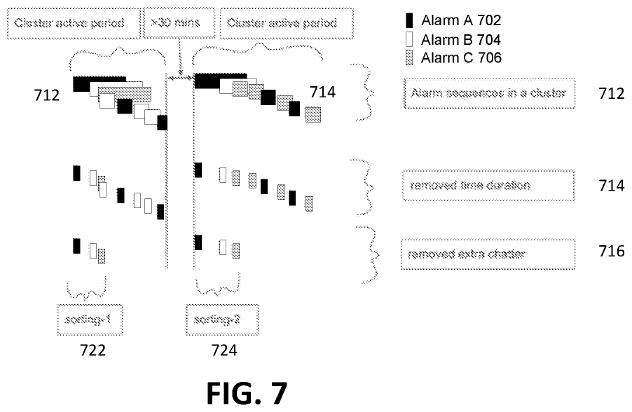

For example, FIG. 7 illustrates occurrences of an alarm A 702, an alarm B 704, and an alarm C 706 in an alarm event stream. The occurrences of the alarms 702, 704, 706 may include a quiet time that is longer than the quiet threshold duration (e.g., 30 minutes). Based on the non-occurrence of alarms for this period of time, the alarm event stream may be split into two sub-sequences 712, 714. Individual sub-sequences 712, 714 may include occurrences of the alarms 702, 704, 706 over a cluster active period. Individual sub-sequences 712, 714 may include alarm sequences in an alarm cluster.

Once the alarm event stream has been separated into one or more of the alarm clusters, one or more directed alarm graphs may be generated from the separated alarm event stream. A directed alarm graph may refer to a graph that utilizes directions of edges between nodes to represent direction/dependency of corresponding alarms. The direction of an edge between two nodes may represent the order in which the corresponding alarms occur. The direction of an edge between two nodes may represent the causal relationship between the corresponding alarms. Generation of directed alarm graph may enable analysis based on direction/dependency between the alarms.

In some implementations, once a portion of the alarm event stream (alarm event stream portion) has been separated into an alarm cluster, a directed alarm graph may be generated by (1) generating alarm sortings, and (2) determining directions of the edges based on alarm directions in the alarm sortings. An alarm sorting may refer to a simplified sequence of alarms within one subs-sequence of alarms (alarms that occur over a cluster active period). For example, FIG. 7 shows a sorting 722 for the sub-sequence 712 and a sorting 724 for the sub-sequence 714. The sortings 712, 714 may be generated by (1) removing the time durations of the alarms 702, 704 706 and (2) duplicative alarms from the sub-sequences 712, 714. Removing the time durations of the alarms 702, 704, 706 may show when the alarms 702, 704, 706 occurred (e.g., were triggered) in the sub-sequences 712, 714. Removing duplicative alarms (extra chatter) may show first instance of when the alarms 702, 704, 706 occurred in the sub-sequences 712, 714. Removing duplicative alarms (e.g., keeping only the first occurrence of each type of alarm) may remove noise created by alarms that chatter/repeat after their first occurrence. The sequence of the first occurrences of the alarms 702, 704, 706 in the sub-sequences 712, 714 may form the sortings 722, 724. The sortings 722, 724 may show the sequence in which the alarms 702, 704, 706 occurred in the sub-sequences 712, 714.

The directions of edges in a directed alarm graph may be determined based on alarm directions in the alarm sortings and/or other information. An alarm direction in an alarm sorting may refer to a direction or an order in which the alarms occur in the alarm sorting. For example, referring to FIG. 7, the alarm direction in the sorting 722 and the sorting 724 may include the alarm A 702, followed by the alarm B 704, followed by the alarm C 706. Based on this alarm direction, a directed alarm graph for the corresponding alarm cluster may be generated to include (1) an edge that travels from a node representing the alarm A 702 to a node representing the alarm B 704, and (2) an edge that travels from the node representing the alarm B 704 to a node representing the alarm C 706. Thus, the sequential pattern of alarm occurrences in the alarm sortings may be used to determine the direction of edges in the directed alarm graph.

Different alarm sortings may include different alarm directions. That is, rather than including the same sequential pattern of alarm occurrences, different alarms sortings may include different sequential patterns of alarm occurrences. Different sequential patterns of alarm occurrences may provide different directions of edges between the nodes. Different alarm sortings may include conflicting alarm directions. For example, one alarm sorting may include an alarm A occurring before an alarm B, while another alarm sorting may include the alarm B occurring before the alarm A.

In some implementations, a strict directional relationship may be required to use the direction of alarms in alarm sortings for the direction of edges in the directed alarm graph. When a strict directional relationship is required, conflicting alarm directions in different alarm sortings may cancel each other out. Confliction alarm directions in different alarm sortings may be treated as anti-evidence of the other and such directions may not be used in the directed alarm graph. For instance, based on confliction direction between the alarms A and B, no edge may exist between the nodes representing the alarms A and B in the directed alarm graph.

In some implementations, a non-strict directional relationship may be required to use the direction of alarms in the alarm sortings for the direction of edges in the directed alarm graph. When a non-strict directional relationship is required, conflicting alarm directions in different alarm sortings may be analyzed to determined how often a particular sequential pattern happens. For example, the direction from alarm A to alarm B may be found in 80% of the alarm sortings while the direction from alarm B to alarm A may be found in 20$ of the alarm sortings. The non-strict directional relationship may use the sequential pattern that happens more frequently in the directed alarm graph. The non-strict directional relationship may use the sequential pattern that happens with a certain degree of frequency (e.g., found in more than 75% of the alarm sortings) in the directed alarm graph. Other use of sequential patterns in alarm sortings for directions of edges in a directed alarm graph is contemplated.

In some implementations, a directed alarm graph may be simplified. Simplifying a directed alarm graph may include removal of one or more edges of the directed alarm graph. The edges of the directed alarm graph may be reduced for being redundant of other edges. An edge may be redundant of other edges if the edge connects the same nodes as the other edges. For example, a directed alarm graph may be reduced to preserve a longest path between two nodes representing two alarms. The directed alarm graph may be simplified by removing shorter parallel paths between two nodes representing two alarms. Other simplification of the directed alarm graph is contemplated.

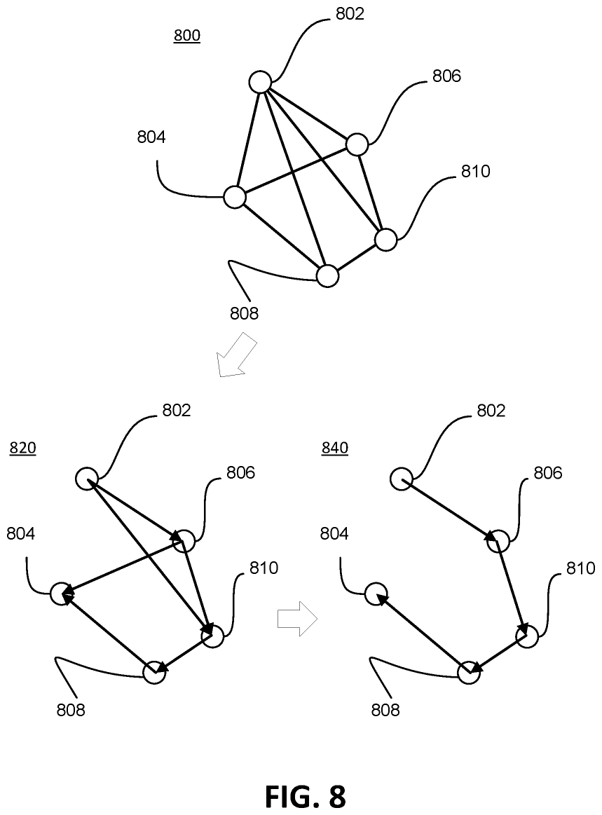

FIG. 8 illustrates example generation of a directed alarm graph 840. The directed alarm graph 840 may be generated for an alarm cluster 800. The alarm cluster 800 may include nodes 802, 804, 806, 808, 810 representing five alarms. The alarm cluster 800 may include edges between (1) the nodes 802, 804, (2) the nodes 802, 806, (3) the nodes 802, 808, (4) the nodes 802, 810, (5) the nodes 804, 808, (6) the nodes 804, 806, (7) the nodes 806, 810, and (8) the nodes 808, 810. Portions of an alarm event stream may be separated into the alarm cluster 800, and alarm sortings may be generated to determine direction of edges in a directed alarm graph 820. For example, based on the sequential patterns in the alarm sortings, the edges between (1) the nodes 802, 804, and (2) the nodes 802, 808 may be removed. Based on the sequential patterns in the alarm sortings, the edges may travel from (1) the node 802 to the node 806, (2) the node 802 to the node 810, (3) the node 806 to the node 804, (4) the node 806 to the node 810, (5) the node 808 to the node 804, and (6) the node 810 to the node 808. The directed alarm graph 820 may be simplified into the directed alarm graph 840. The directed alarm graph 840 may preserve the longest path between the node 802 and the node 804. The edge between the nodes 802, 810 may be removed as being duplicative and shorter of the edges between the nodes 802, 806 and the nodes 806, 810. The edge between the nodes 804, 806 may be removed as being duplicative and shorter of the edges between the nodes 806, 810, the nodes 808, 810, and the nodes 804, 808. The directed alarm graph 840 may be a directed acyclic graph. The directed alarm graph 840 may provide a structural/directional estimation of the alarms in the alarm cluster 800. The directed alarm graph 840 may provide an ordering/dependency of related alarms in graph form.

In some implementations, facilitation of the root cause analysis of the sequence of alarms based on the alarm clusters may include determination of a root-causeness score for a given alarm. For example, a root-causeness score may be determined for alarms represented by the nodes 802, 804, 806, 808, 810 in the alarm cluster 800. The root-causeness score for an alarm may indicate an extent to which the alarm occurs at a beginning of an alarm flood. The root-causeness score for an alarm may provide a value that quantifies the likelihood that the alarm will start a sequence of related alarms.

In some implementations, a root-causeness score for an alarm may be determined based on where the alarm appears in different alarm sortings. Alarms in alarm sortings may be assigned a value based on the where in the sequential pattern they occur (e.g., assign a value of “1” to the first alarm in the alarm sorting, assign a value of “2” to the second alarm in alarm sorting) and the assigned values for different alarms across the alarm sortings may be combined (e.g., averaged) to determine the root-causeness score. In some implementations, the root-causeness scores for alarms may be normalized (e.g., between zero and one, with values closer to one indicating that the alarms occur closer to the beginning of the alarm flood and values closer to zero indicating that the alarms occur closer to the end of the alarm flood).

In some implementations, facilitation of the root cause analysis of the sequence of alarms based on the alarm clusters may include determination of a root cause of an alarm flood. The root cause of the alarm flood may be determined by using the directed alarm graph for the alarm flood. The directed alarm graph for the alarm flood may include nodes for active alarms (alarms that occurred within a cluster active period) and directed edges between the alarms that define the relationship/dependency between the alarms. Nodes for non-active alarms may not be included in the directed alarm graph or may be made inactive. The root cause of the alarm flood may be determined as the alarm(s) represented by node(s) (active node(s)) with in-degree of zero. That is, the root cause of the alarm flood may be determined as the alarm(s) represented by node(s) that do not have any parent nodes (active parent nodes).

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

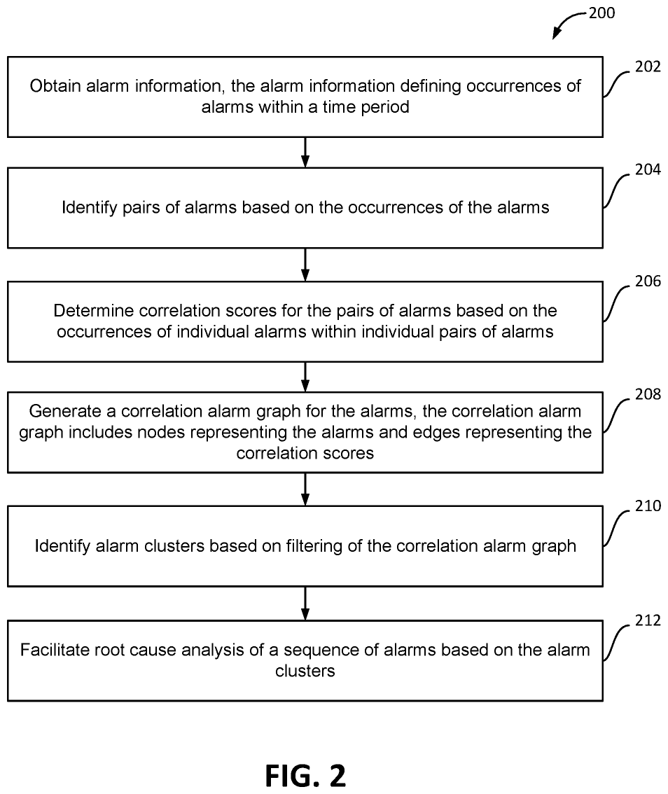

FIG. 2 illustrates method 200 for performing alarm root cause analysis. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, alarm information and/or other information may be obtained. The alarm information may define occurrences of alarms within a time period. In some implementation, operation 202 may be performed by a processor component the same as or similar to the alarm component 102 (Shown in FIG. 1 and described herein).

At operation 204, pairs of alarms may be identified based on the occurrences of the alarms and/or other information. In some implementation, operation 204 may be performed by a processor component the same as or similar to the alarm pair component 104 (Shown in FIG. 1 and described herein).

At operation 206, correlation scores for the pairs of alarms may be determined based on the occurrences of individual alarms within individual pairs of alarms and/or other information. In some implementation, operation 206 may be performed by a processor component the same as or similar to the correlation score component 106 (Shown in FIG. 1 and described herein).

At operation 208, a correlation alarm graph for the alarms may be generated. The correlation alarm graph may include nodes representing the alarms and edges representing the correlation scores. In some implementation, operation 208 may be performed by a processor component the same as or similar to the correlation alarm graph component 108 (Shown in FIG. 1 and described herein).

At operation 210, alarm clusters may be identified based on filtering of the correlation alarm graph and/or other information. In some implementation, operation 210 may be performed by a processor component the same as or similar to the alarm cluster component 110 (Shown in FIG. 1 and described herein).

At operation 212, root cause analysis of a sequence of alarms may be facilitated based on the alarm clusters and/or other information. In some implementation, operation 212 may be performed by a processor component the same as or similar to the root cause analysis component 112 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for performing alarm root cause analysis, the system comprising:
one or more physical processors configured by machine-readable instructions to:
obtain alarm information, the alarm information defining occurrences of alarms within a time period;
identify pairs of alarms based on the occurrences of the alarms;
determine correlation scores for the pairs of alarms based on the occurrences of individual alarms within individual pairs of alarms;
generate a correlation alarm graph for the alarms, the correlation alarm graph includes nodes representing the alarms and edges representing the correlation scores;
identify alarm clusters based on filtering of the correlation alarm graph; and
facilitate root cause analysis of a sequence of alarms based on the alarm clusters.

2. The system of claim 1, wherein identification of the pairs of alarms based on the occurrences of the alarms includes identification of alarm pairs with trigger times within a threshold duration of time.

3. The system of claim 1, wherein determination of the correlation scores for the pairs of alarms based on the occurrences of individual alarms within individual pairs of alarms includes, for a given pair of alarms including a first alarm and a second alarm:
generation of equal-length lists for the given pair of alarms, the equal-length lists including a first list for the first alarm and a second list for the second alarm;
population of values of the equal-length lists for the given pair of alarms based on the occurrences of the individual alarms; and
determination of a given correlation score for the given pair of alarms based on the values of the equal-length lists for the given pair of alarms.

4. The system of claim 3, wherein at least one of the values of the first list is determined based on decay of another one of the values of the first list.

5. The system of claim 1, wherein identification of the alarm clusters based on filtering of the correlation alarm graph includes removal of the edges of the correlation alarm graph representing the correlation scores below a threshold correlation score, wherein the removal of the edges of the correlation alarm graph results in subgraphs representing the alarm clusters.

6. The system of claim 1, wherein facilitation of the root cause analysis of the sequence of alarms based on the alarm clusters includes:
reception of an alarm event stream;
separation of the alarm event stream into one or more of the alarm clusters; and
generation of one or more directed alarm graphs from the alarm event stream separated into the one or more of the alarm clusters.

7. The system of claim 6, wherein the generation of the one or more directed alarm graphs includes, for a given directed alarm graph generated from an alarm event stream portion separated into a given alarm cluster:
generation of alarm sortings based on removal of duplicative alarms in the given alarm cluster; and
determination of directions in the given directed alarm graph based on alarm directions in the alarm sortings.

8. The system of claim 7, wherein the given directed alarm graph is reduced to preserve a longest path between two nodes representing two alarms.

9. The system of claim 1, wherein facilitation of the root cause analysis of the sequence of alarms based on the alarm clusters includes determination of a root-causeness score for a given alarm, the root-causeness score indicating an extent to which the given alarm occurs at a beginning of an alarm flood.

10. The system of claim 1, wherein facilitation of the root cause analysis of the sequence of alarms based on the alarm clusters includes determination of a root cause of an alarm flood.

11. A method for performing alarm root cause analysis, the method comprising:
obtaining alarm information, the alarm information defining occurrences of alarms within a time period;
identifying pairs of alarms based on the occurrences of the alarms;
determining correlation scores for the pairs of alarms based on the occurrences of individual alarms within individual pairs of alarms;
generating a correlation alarm graph for the alarms, the correlation alarm graph includes nodes representing the alarms and edges representing the correlation scores;
identifying alarm clusters based on filtering of the correlation alarm graph; and
facilitating root cause analysis of a sequence of alarms based on the alarm clusters.

12. The method of claim 11, wherein identifying the pairs of alarms based on the occurrences of the alarms includes identifying alarm pairs with trigger times within a threshold duration of time.

13. The method of claim 11, wherein determining the correlation scores for the pairs of alarms based on the occurrences of individual alarms within individual pairs of alarms includes, for a given pair of alarms including a first alarm and a second alarm:
generating equal-length lists for the given pair of alarms, the equal-length lists including a first list for the first alarm and a second list for the second alarm;
populating values of the equal-length lists for the given pair of alarms based on the occurrences of the individual alarms; and
determining a given correlation score for the given pair of alarms based on the values of the equal-length lists for the given pair of alarms.

14. The method of claim 13, wherein at least one of the values of the first list is determined based on decay of another one of the values of the first list.

15. The method of claim 11, wherein identifying the alarm clusters based on filtering of the correlation alarm graph includes removal of the edges of the correlation alarm graph representing the correlation scores below a threshold correlation score, wherein the removal of the edges of the correlation alarm graph results in subgraphs representing the alarm clusters.

16. The method of claim 11, wherein facilitating the root cause analysis of the sequence of alarms based on the alarm clusters includes:
receiving an alarm event stream;
separating the alarm event stream into one or more of the alarm clusters; and
generating one or more directed alarm graphs from the alarm event stream separated into the one or more of the alarm clusters.

17. The method of claim 16, wherein generating the one or more directed alarm graphs includes, for a given directed alarm graph generated from an alarm event stream portion separated into a given alarm cluster:
generating alarm sortings based on removal of duplicative alarms in the given alarm cluster; and
determining directions in the given directed alarm graph based on alarm directions in the alarm sortings.

18. The method of claim 17, wherein the given directed alarm graph is reduced to preserve a longest path between two nodes representing two alarms.

19. The method of claim 11, wherein facilitating the root cause analysis of the sequence of alarms based on the alarm clusters includes determining a root-causeness score for a given alarm, the root-causeness score indicating an extent to which the given alarm occurs at a beginning of an alarm flood.

20. The method of claim 11, wherein facilitating the root cause analysis of the sequence of alarms based on the alarm clusters includes determining a root cause of an alarm flood.
